(19) United States
(12) Patent Application Publication
(10) Pub. No.: US 2014/0190953 A1
(43) Pub. Date: Jul. 10, 2014

(54) ROLLER FOR HEATING A PAPER WEB OR FABRIC

(71) Applicant: QUANTUM TECHNOLOGIE (DEUTSCHLAND) GMBH, Munich (DE)

(72) Inventor: Ki CHAN, Hong Kong (CN)

(73) Assignee: QUANTUM TECHNOLOGIE (DEUTSCHLAND) GMBH, Munich (DE)

(21) Appl. No.: 14/209,516

(22) Filed: Mar. 13, 2014

Related U.S. Application Data
(63) Continuation of application No. PCT/EP2012/061504, filed on Jun. 15, 2012.

(30) Foreign Application Priority Data
Sep. 13, 2011 (EP) 11181138.6

(51) Int. Cl. D21F 5/02; F16C 13/00

(52) U.S. Cl. CPC D21F 5/024; F16C 13/00
USPC 219/469; 492/46

(57) ABSTRACT

A heated roller for heating a paper web or fabric web with a cylindrical roller shell, a front side and a rear side permits a homogenous temperature on its surface if the cylindrical roller shell surrounds an inner roller shell thereby forming a ring like or at least one ring segment like hollow space between the cylindrical roller shell and the inner roller shell and if at least one heat source is inserted in the hollow space.

### PRIORITY CLAIM

This application claims priority to pending European Application No. 11181138.6 filed on Sep. 13, 2011.

This application is a continuation of pending International Application No. PCT/EP2012/061504 filed on 15 Jun. 2012, and which was published as WO 2013/037522which designates the United States and claims priority from European Application No. 11181138.6 filed on Sep. 13, 2011.

### BACKGROUND OF THE INVENTION

1. Field of the Invention

The invention relates to a roller for heating a web of paper or fabric with a cylindrical roller shell, a front side and a rear side and a rotational axis. The cylindrical roller shell is heated by at least one heat source.

2. Description of Relevant Art

In paper and fabric industry wet paper web or a wet fabric web, respectively, are transported through a drying section to remove excess water from the paper web or fabric web. In the drying section the web travels over heated drum dryers which are as well called rollers. The rollers are typically heated with steam. Such a roller is e.g. disclosed in the patent application DE 10 2005 043 734 A1. Supplying the rollers with steam is expensive and the humidity provided by the steam is difficult to handle in the drums. Further, it is difficult to provide a homogenous surface temperature of the roller. The humidity problem can be solved by using heated oil instead of steam, but the other shortcomings remain unresolved.

A different approach is disclosed in the US-patent publication 5,666,744: The wet paper web is transferred to a fabric conveyor sheet and travels though a drying unit. In the drying unit the wet paper web on the fabric sheet is exposed to infrared light emitted by infrared units positioned along the traveling path of the wet paper web. At the same time the moisture is removed by vacuum units positioned on the opposite site of fabric sheet from the infrared unit. This permits to combine heat drying and vacuum drying.

The international patent application published as WO 2010/020485 A1 suggests to dry a wet paper web by micro waves. The paper web crosses a gap between opposed rollers multiple times. In the gap the wet paper web is exposed to the micro waves. This method has the shortcoming that the paper web has to travel the gap multiple times and that it is difficult to provide an homogeneous micro wave intensity within the gap. Further, the gap must be perfectly shielded against leaking radiation.

U.S. Pat. No. 4,990,751 discloses an electrically heated roller for drying a paper web. The roller has an outer shell, having the form of a tube like hollow cylinder. In the cylinder is a second hollow cylinder. On the surface shell of the second hollow cylinder are parallel bars supporting strands in a ring like hollow space between the outer shell and the second hollow cylinder. An electric current is provided to the strands, to thereby produce heat. The heat is transferred to the outer shell as radiant heat.

DE 30 33 689 A1 discloses as well an electrically heated roller for drying a paper web with two concentrically arranged hollow cylinders. Between the inner and the outer cylinder is a compartment. In the compartment are electric heating pads, which are in thermal contact with the inner and the outer hollow cylinder. This arrangement of the heating pads provides a uniform heat distribution.

German Utility Patent DE 201 01 859 U1 discloses a further embodiment of an electrically heated drying roller. The drying roller has tube like hollow cylinder as roller shell. The cylinder has a couple of bores, being parallel to the cylinder axis. In each of the bores is a heater wire. Heat produced by applying a current through the heater wires is transferred as radiant heat to the hollow cylinder.

U.S. Pat. No. 4,158,128 discloses a heated roller for processing sheet material by applying a uniform load across the width of the sheet material. To this end the roller comprises a core and a shell of two coaxial pipes. The ends of the pipes are interconnected by a hermetic joint to thereby form a space between the pipes. A fluid for heating or cooling the roller circulates in the space. Alternatively the space may accommodate electrical heaters. The core of the roller has a middle section with a constant outer diameter that corresponds to the inner diameter the inner pipe thereby bearing the pipes, i.e. the inner pipe rests on the middle section of the core. At both sides of the middle section the outer diameter of the core is reduced and the pipes overlap the middle section.

EP 0 156 790 discloses as well a roller with a pipe like shell. The pipe like shell is supported by a hollow single shaft via hubs and heated by electrical heating elements. For providing a uniform heat distribution a low melting metal, low meting alloy or low melting salt is incorporated in roller.

DE 102 01 380 A1 discloses a roller with a roller shell. In the roller shell are bores parallel to the roller axis for accommodating electrical heating elements. The heating elements are each supported by fixtures in the respective bore such that the there is no direct contact between the roller shell and the heating elements, to thereby heat the roller only by radiant heat. For supporting the roller shell, the figures show a cylindrical single shaft supporting the roller shell over its full width.

DE 30 33 689 A1 discloses a heated roller having an inner pipe and as roller shell a coaxial outer pipe. Heating pads are arranged between the inner and the outer pipes. At both facing sides of the inner and outer pipes are discs being flanged to the pipes. Each disc has a shaft for supporting the discs and thereby the inner and outer pipes.

Although the cited documents disclose related art, the above summaries of the respective cited documents are not intended to be applicants admitted prior art, but rely on applicant's analysis of the cited documents.

### SUMMARY OF THE INVENTION

The problem to be solved by the invention is to provide a simple and at the same time efficient drying station for a web of paper or fabric, subsequently briefly referred to as “web”.

The invention is based on the observation, that the electrically heated rollers of the prior art either require a lateral thermal contact to the roller drum or that the heat is transferred as radiant heat to the roller drum. In the first case, the heating elements are difficult to replace. In the second case the heat transfer between the heating elements and the roller drum is not efficient.

Solutions of the problem are described in the independent claims. The dependent claims relate to advantageous embodiments of the invention.

The roller of claim 1 comprises at least a cylindrical roller shell with a cylinder axis, a front side and a rear side. The cylinder axis is the rotational axis. The cylindrical roller shell comprises at least one, preferably multiple bores, which extend at least approximately parallel to the cylinder axis. The bores may be through holes, i.e., connect the two facing sides of the roller shell. In at least one of the bores is at least one, preferably replaceable, slab like heater cartridge. The heater cartridge has a surface that is in thermal contact with the bore's inner surface. The heater cartridge is preferably an encapsulated heating element, i.e. heat is provided by heating an encapsulating housing of the heating elements. The length of the cartridge may be shorter than the length of the bore, e.g. smaller ½, smaller ⅓, smaller ¼ or even less of the bore's length. Such heater cartridges are commercially available and can be replaced very quickly, thus the tooling time can be kept low. In the bore is preferably a liquid inorganic compound for example a solution comprising inorganic salts. When heating the heater cartridge, the solvent of the solution evaporates. The inner surface of the bore is thus coated with the inorganic salts. The inorganic salts provide for an at least almost perfect thermal contact between the heater cartridge and the inner surface of the bore. In addition the coating dramatically enhances the thermal conductivity of the bore.

Before inserting the liquid inorganic compound into the bore the bore is preferably evacuated. Subsequently an amount of the liquid inorganic compound is inserted in the bore and the bore is sealed. When heating the roller with the heater cartridges the solvent will change its phase and become a gas. The inorganic salts will remain evenly distributed at the inner surface of the bore and thus coat the bore. Preferably the drum is rotated while heated, to better distribute the inorganic salts and other possible constituents of the liquid inorganic compound. Examples for suited liquid inorganic compounds can be found e.g. in patents U.S. Pat. No. 6,132,823, U.S. Pat. No. 6,911,231, U.S. Pat. No. 6,916,430, U.S. Pat. No. 6,811,720 and the application US2005/0056807, which are incorporated by reference as if fully disclosed herein.

In a second embodiment the cylindrical roller shell surrounds an inner roller shell and forms thereby a ring like or at least one ring segment like hollow space between the cylindrical roller shell and the inner roller shell. In the hollow space between the cylindrical outer roller shell and the inner roller shell is at least one heat source, e.g. a replaceable mounted slab like heater cartridge. The heat source is thermally connected to at least one of the cylindrical roller shell and/or the inner roller shell. For thermally contacting the heating element, the heating element can be inserted into the hollow space, the hollow space can be evacuated and subsequently a liquid inorganic compound for example a solution of at least one inorganic salt can be inserted in the hollow space. Subsequently a predefined amount of a solution of at least one inorganic salt, for example one of the solutions disclosed in at least one of the patents U.S. Pat. No. 6,132,823, U.S. Pat. No. 6,911,231, U.S. Pat. No. 6,916,430, U.S. Pat. No. 6,811,720 and/or the application US2005/0056807, is filed in the bore. The pressure in the bore is still kept well below the ambient pressure. Now the roller is preferably rotated and the heating elements are switched on. The liquid inorganic compound is thereby evenly dispersed in the bore and at the same time evaporated, thus the inorganic salt coat the surface of the heater cartridge and at the same time inner surface of the hollow space, thereby thermally connecting the heating element and the roller shells.

Both constructions permit a light weight and however stable roller which can thus quickly be accelerated or stopped, due to its low moment of inertia. The heat sources can be almost freely arranged within the hollow space ore bores, respectively and thereby a uniform temperate on the roller's surface can be maintained. The hollow space can be coated like the bores with inorganic salts and may be evacuated to enhance the heat conductivity of the opposed surfaces of the hollow space, e.g. like it is described in the patents U.S. Pat. No. 6,132,823, U.S. Pat. No. 6,911,231, U.S. Pat. No. 6,916,430, U.S. Pat. No. 6,811,720 and the application US2005/0056807. This permits at least an almost perfect homogenous heat distribution.

More generally one may summarize the invention as providing a drying roller with at least one tube like roller shell. The roller has at least one recess or compartment, into which at least one heating element, e.g. a heater cartridge, is inserted. The heating element is thermally connected to the roller shell by coating of at least one inorganic salt. The method for thermally connecting the heating element to the roller shell may be summarized as follows: In a first step the recess is evacuated and a liquid inorganic compound, for example a solution of the at least one inorganic salt is inserted in the recess. Subsequently the roller is heated and preferably at the same time rotated. Thereby the liquid inorganic compound evenly distributes in the recess and is at the same time evaporated. Thus the inorganic salts remains as coating on the heating element and the inner surface of the recess.

In a preferred embodiment at least one heat source is at least one slab like electrical heater element, which is thermally connected to the at least one inner roller shell. This enables to arrange the heater elements preferably evenly spaced and circumferentially of the inner shell and thereby further enhance the heat distribution on the cylinder's surface. Such heater elements can be replaced very quickly, thus the tooling time can be kept low.

For example, in a preferred embodiment the heat source comprises multiples lab like electrical heater elements, being arranged in parallel to each other on the outer surface of the inner roller shell and in parallel to the rotational axis of the roller.

In a preferred embodiment the inner roller shell has at least one recess for the at least one heat source. This provides an optimized heat transfer between the heat source and the inner roller shell and as well a good heat transfer between the inner shell and the cylindrical roller shell due to a reduced average distance between the inner shell and the cylinder.

If the heat source is inserted from the front and/or rear side of the drum into the hollow space or the bore, respectively it can be efficiently supplied with energy, preferably electricity, and can be replaced quickly in case of failure.

The at least one of the roller shells is preferably reinforced by least one ring with an outer narrow side and an inner narrow side, wherein the outer narrow side statically contacts the inner side of the respective roller shell. This stabilizes the roller, without significant increase of weight.

The roller is further stabilized if the cylindrical roller shell and the inner roller shell are attached to disks at the front and the rear side of the roller.

In a preferred embodiment the roller has roller shaft, which supports at least one slip ring, the latter being electrically connected with the at least one heat source for supplying electric energy to the at least one heat source.

Preferably the roller shaft has two halves, each being shorter than the width of the roller, one of which is mounted at the facing sides, i.e. the front and the rear side, respectively, of the roller. For example, the shaft may be preferably statically mounted to the discs being attached to the cylindrical roller shell and the inner roller shell at the front and the rear side of the roller. Thus there may be a fixed connection between the cylindrical roller shell and the shaft's halves. This enable a simple support of the roller e.g. by standard bearings without significant increase of the moment of inertia of the roller.

### BRIEF DESCRIPTION OF THE DRAWINGS

In the following, the invention will be described by way of example, without limitation of the general inventive concept, on examples of embodiment and with reference to the drawings.

FIG. 1 shows a cross section of a roller.

FIG. 2 shows a detail of FIG. 1.

FIG. 3 shows a view on the front side of the roller of FIG. 1

FIG. 4 shows a view of a disk to be mounted at the rear side of the roller of FIG. 1.

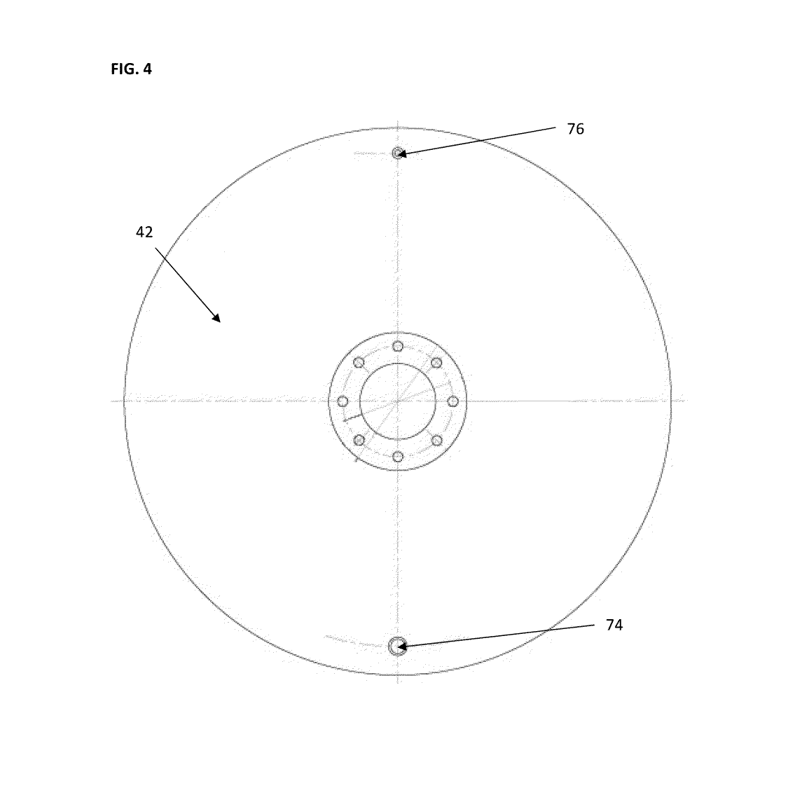

FIG. 5 shows a further embodiment of a roller.

FIG. 6 shows a detail of FIG. 5

FIG. 7 shows cross sections A-A and B-B as indicated in FIG. 5.

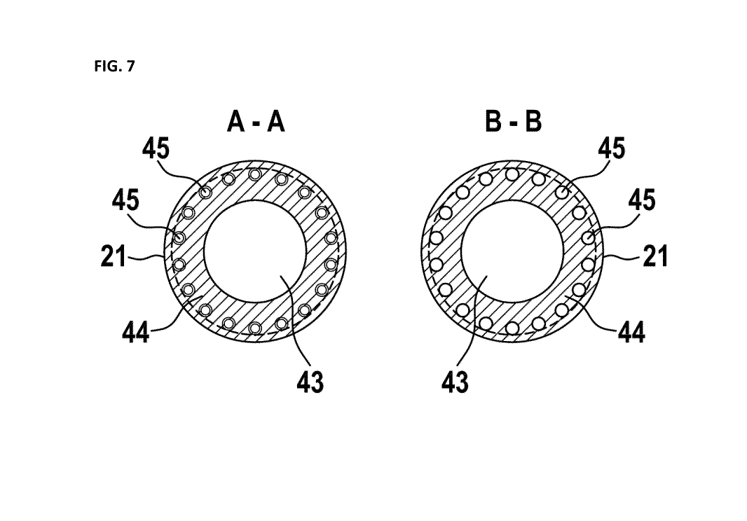

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

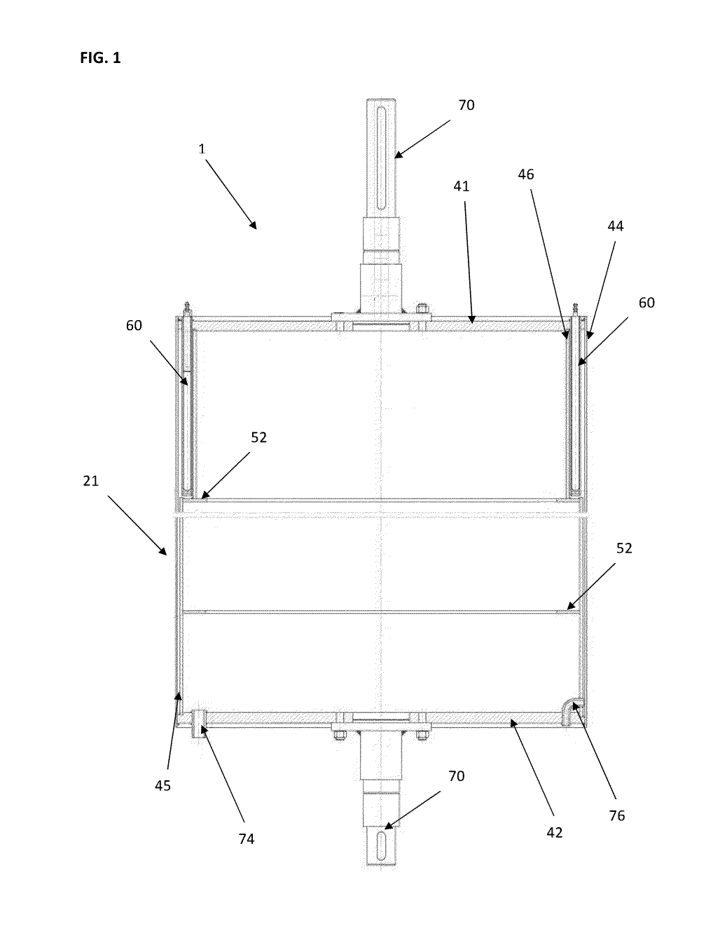

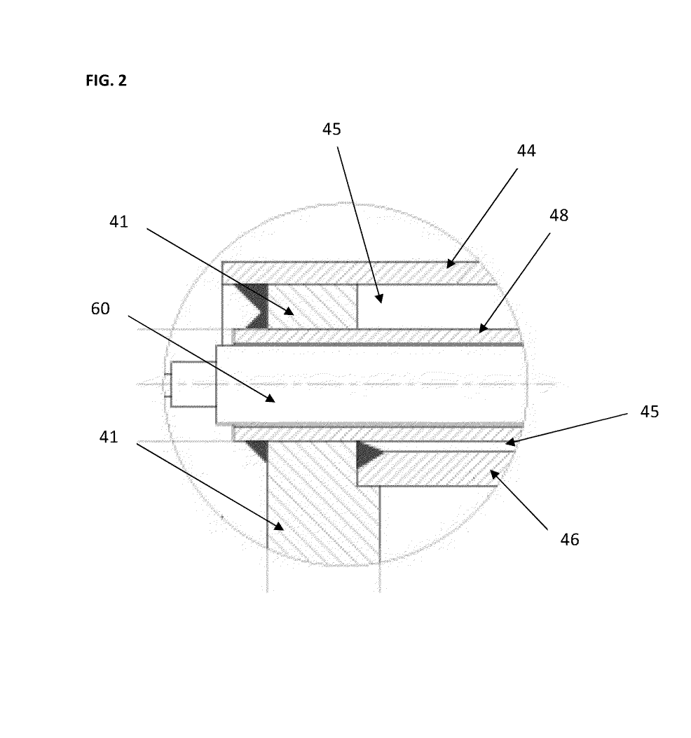

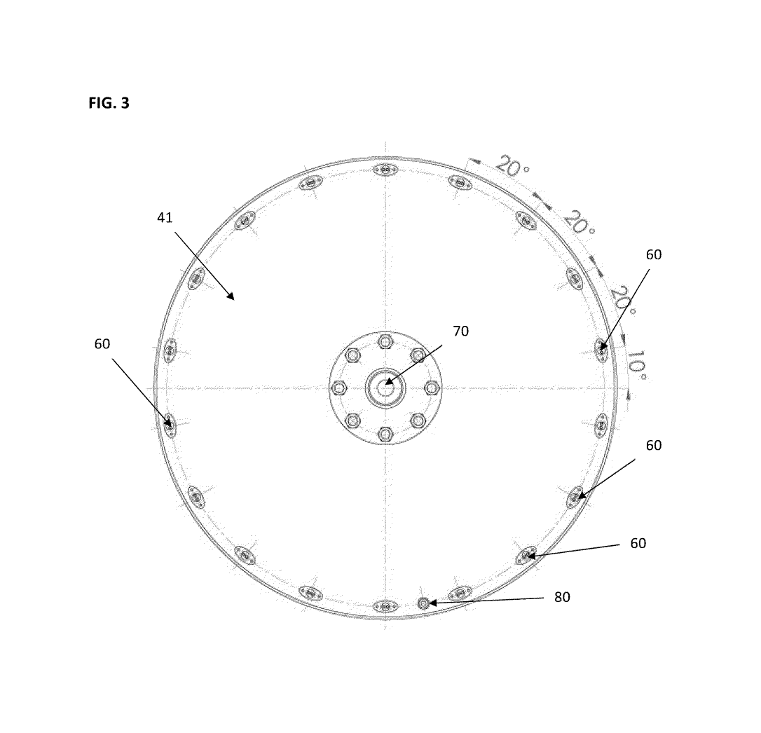

The roller 1 in FIG. 1 has the shape of a hollow ring like cylinder with a cylinder surface 21 as rest for a paper web (not shown). Both facing sides of the hollow cylinder are at least essentially closed by a front disk 41 and rear disk 42. The parallel disks 41, 42 support a cylindrical roller shell 44 (cf. FIG. 1). The cylindrical roller shell 44 encloses an inner roller shell 46. The inner roller shell 46 is spaced in a radial direction from the cylindrical roller shell 44. The the inner roller shell 46, the cylindrical roller shell 44 and the two disks 41, 42 form a ring like hollow space 45. The outer diameter of the hollow space 45 is defined by the inner surface of the cylindrical roller shell 44. The inner diameter of the hollow space 45 is defined by the adjacent surface of the inner roller shell and is reduced by a step from the front to the rear, i.e. it has two sections with different diameters. The wider section permits insertion of casings 48 as compartments for electrical heater elements 60. The electrical heater elements 60 are inserted from the front side and extend through the front disk 41 with their electrical connectors (cf. FIG. 2, FIG. 3).

Preferably the surfaces enclosing the hollow space 45 is coated as disclosed in the patents U.S. Pat. No. 6,132,823, U.S. Pat. No. 6,911,231, U.S. Pat. No. 6,916,430, U.S. Pat. No. 6,811,720 and the application US2005/0056807, which are incorporated by reference as if fully disclosed herein. The coating fluid can be inserted into the hollow space 45 through a tube 76. Subsequent to the coating process the hollow space is preferably evacuated as well via tube 76. The tube 76 can as well be used for testing the structural integrity of the hollow space under extremely low and/or high pressures. Of course the tube 76 can be closed, e.g. by a bolt and/or a valve.

The inner roller shell is reinforced by rings like 52 with an outer narrow side and an inner narrow side, wherein the outer narrow side statically contacts the inner side of the inner roller shell 46 and thereby stabilizes the roller 1 without significant increase of weight and thus without significant moment of inertia. The difference d between the inner and the outer diameters of the rings 52 is smaller than ⅓ of the radius r of the cylindrical roller 44, more preferably smaller than ¼ of the radius r of the cylindrical roller 44.

From both disks 41, 42 extends a half of a roller shaft 70, flanged to the respective disk 41, 42, thereby enabling to bear the roller 1 in a supporting frame (not shown). A temperature sensor 80 extends from the front disk 41 into the hollow space 45 (cf. FIG. 3) and permits a control unit to maintain the temperature at a defined value or interval.

The rear disk 42 has an opening 74 to chamber 72 formed by the inner shell and the two disks 41, 42. The opening 74 ensures ventilation of the chamber 72, in addition the chamber can easily be inspected (cf. FIG. 1, 4).

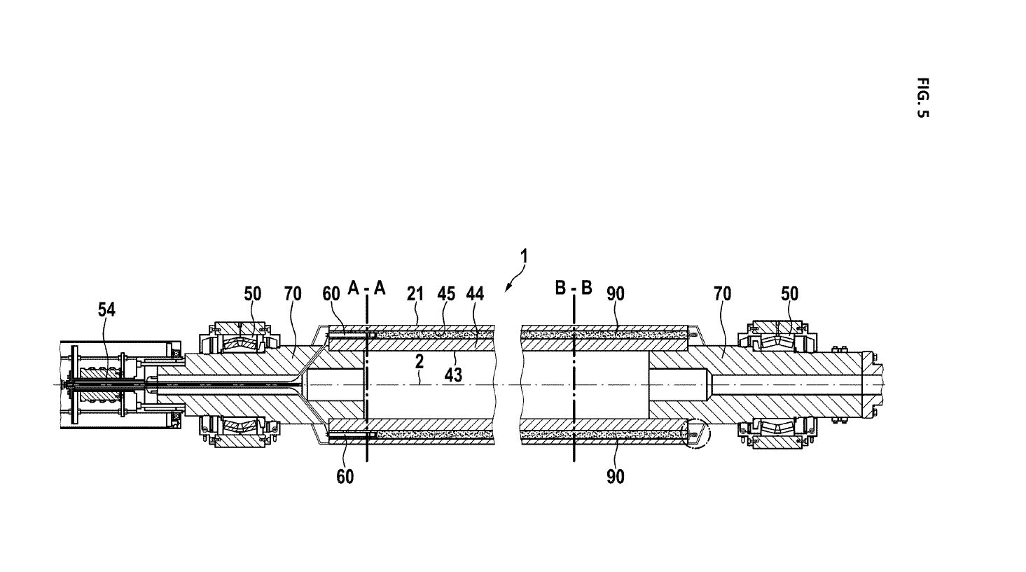

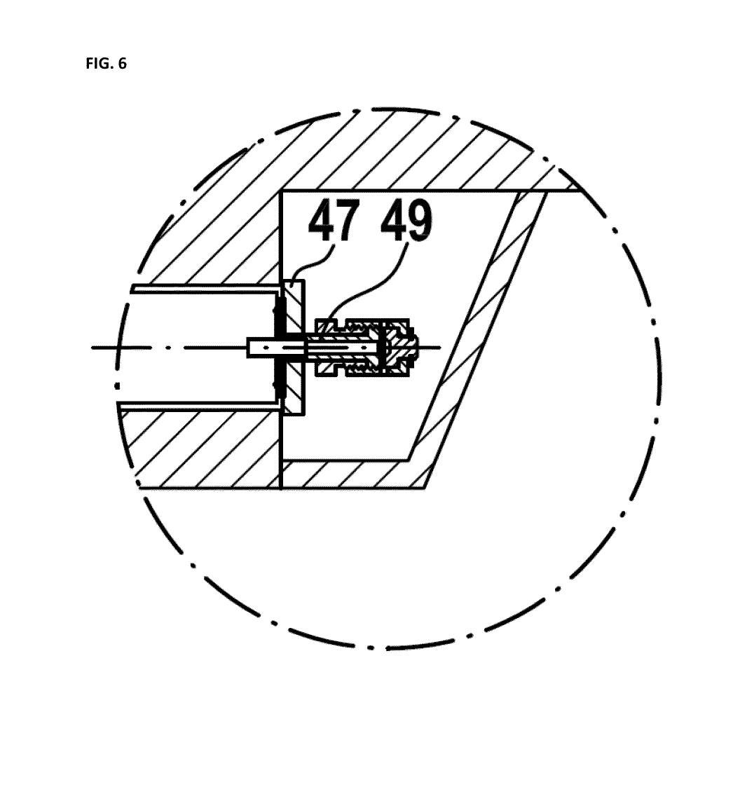

The roller 1 in FIG. 5 has a roller drum of a tube like hollow cylindrical roller shell 44 with a cylinder axis 2 (c.f. FIG. 6). The outer cylinder surface is the roller surface 21 for supporting and heating a paper web. In the roller shell 44 are a couple of recesses 45, which are in this example bores 45. The recesses 45 extend at least approximately parallel to the cylinder axis 2. Only small deviations from the axial direction of the cylinder axis should be tolerated. The difference in the distance of the recess 45 to the cylinder axis 2 at one facing side of the roller shell 44 to the respective distance at the opposite facing side of the roller shell 44 is preferably smaller than +/−0.1 mm. The bores 45 are through holes spanning from one facing side of the roller shell 44 to the opposite facing side of the roller shell 44. One side of each of the bores 45 is closed by insertion of a slab like heater cartridge 60, which seals the respective opening of the bore 45. The heater cartridge is preferably fastened by bolts or any other releasable fastening means. In case of failure of a heater cartridge it can be replaced, by releasing the fastening means and retracting the heater cartridge. Subsequently a new one can be inserted in the bore 45 and fastened. The bore is closed at the opposite facing side of the roller shell by a cover plate 47. The cover plate 47 supports an injection device 47 for evacuating the bore and subsequently filling a predefined amount of a liquid inorganic compound, e.g., an aqueous solution of at least one inorganic salt in the bore 45. The distance between each bore depends on the diameter of the roller drum. The angle error should be kept small, preferably smaller than 0.1°.

The roller shell 44 has the form of a ring like hollow cylinder, and thus has a central trough hole 43. The roller shell 44 is supported by two shafts 70, being inserted into the through hole 43, one from each facing side of the roller shell 44. The outer diameter of the proximal end sections of shafts 70 fits to the inner diameter of the roller shaft 44. The roller shell 44 may be fastened to the shafts 70 by bolts or by welding. The shafts 70 are each supported by a bearing assembly 50, which may be mounted to a supporting frame. The heater cartridges 60 are connected via cables and a rotary joint 54 to a power supply.

For thermally connecting the heater cartridge with the roller shell 44, the bore is in a first step evacuated, this means at least a part of the air in the closed bore is removed to obtain a lower than ambient pressure in the bore. Subsequently a predefined amount of a liquid inorganic compound, for example a solution of at least one inorganic salt, for example one of the liquid inorganic compounds disclosed in at least one of the patents U.S. Pat. No. 6,132,823, U.S. Pat. No. 6,911,231, U.S. Pat. No. 6,916,430, U.S. Pat. No. 6,811,720 and/or the application US2005/0056807, is filled in the bore. The pressure in the bore is still kept well below the ambient pressure. Now the roller shell 44 is preferably rotated and the heater cartridges are switched on. The liquid inorganic compound is thereby evenly dispersed in the bore and at the same time evaporated, thus the inorganic salt(s) coat the surface of the heater cartridge and at the same time the inner surface of the recesses 45, thereby thermally connecting the heater cartridge and the roller shell 44.

It will be appreciated to those skilled in the art having the benefit of this disclosure that this invention is believed to provide heated roller for heating a web of paper or fabric. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 roller
2 cylinder axis
21 roller surface
41 disk
42 disk
43 central through hole of roller shell 44
44 cylindrical roller shell
45 hollow space/bore/recess
46 inner roller shell
47 cover plate
48 casing
49 injection device
52 ring
54 slipring/ rotary joint
60 heat source/electrical heater/heater cartridge
70 shaft
72 chamber
74 opening
76 tube
80 temperature sensor
90 solution/fluid/inorganic salts

1. A heated roller for heating a web of paper or fabric with a cylindrical roller shell, a front side and a rear side, wherein
the cylindrical roller shell surrounds an inner roller shell thereby forming a hollow space having the form of a ring or at least of a ring segment between the cylindrical roller shell and the inner roller shell,
the inner roller shell has at least one casing, which extends from the front and/or rear side into the hollow space, supporting at least one heat source and being connected to at least one of the inner roller shell and/or the cylindrical roller shell by at least one inorganic salt,
the cylindrical roller shell is supported by two shafts, being inserted into a through hole, one from each facing side of the roller shell.

2. The roller of claim 1 wherein
the at least one heat source is at least one slab like electrical heater element, which is thermally connected to the at least one inner roller shell.

3. The roller of claim 1 wherein
the heat source comprises multiple slab like encapsulated electrical heater elements, being arranged in parallel to each other on the outer surface of the inner roller shell or in at least one bore of the cylindrical roller shell and in parallel to a rotational axis of the roller.

4. The roller of claims 1 wherein
the hollow space is connected via a tube like connector with the front and/or rear side of the roll.

5. The roller of claim 1 wherein
the heat source is inserted from the front and/or rear side of the drum into the hollow space or bore, respectively.

6. The roller of claim 1 wherein
the inner roller shell is reinforced by least one ring with an outer narrow side and an inner narrow side, wherein the outer narrow side statically contacts the inner side of the inner roller shell.

7. The roller of claim 1 wherein
the cylindrical roller shell and the inner roller shell are attached to disks at the front and the rear side of the roller.

8. The roller of claim 1 wherein
the roller has at least one roller shaft supporting at least one slip ring, the latter being electrically connected with the at least one heat source for supplying electric energy to the at least one heat source.

9. The roller of claim 1 wherein
the hollow space is evacuated and in that the inner surface is coated with inorganic salts.

10. A heated roller for heating a web of paper or fabric comprising at least a cylindrical roller shell having a cylinder axis, a front side and a rear side, wherein
the cylindrical roller shell comprises at least one bore extending at least approximately parallel to the cylinder axis,
the heated roller further comprises at least one heater cartridge is inserted in at least one of the bores and being thermally connected to said cylindrical roller shell by at least one inorganic salt,
the cylindrical roller shell is supported by two shafts, being inserted into a through hole, one from each facing side of the roller shell.

11. The roller of claim 10 wherein
the at least one heat source is at least one slab like electrical heater element, which is thermally connected to the at least one inner roller shell.

12. The roller of claim 10, wherein
the heat source comprises multiple slab like encapsulated electrical heater elements, being arranged in parallel to each other on the outer surface of the inner roller shell or in the at least one bore, respectively and in parallel to a rotational axis of the roller.

13. The roller of claim 10 wherein
wherein the hollow space is connected via a tube like connector with the front and/or rear side of the roll.

14. The roller of one claim 10 wherein
the heat source is inserted from the front and/or rear side of the drum into the hollow space or bore, respectively.

15. The roller of claim 10 wherein
the inner roller shell is reinforced by least one ring with an outer narrow side and an inner narrow side, wherein the outer narrow side statically contacts the inner side of the inner roller shell.
